(19) United States
(12) Patent Application Publication
(10) Pub. No.: US 2024/0133730 A1
(43) Pub. Date: Apr. 25, 2024

(54) RESIDUAL FEED ESTIMATION MANAGEMENT SERVER FOR FEED BIN AND RESIDUAL FEED ESTIMATION SYSTEM

(71) Applicant: AIMBE LAB INC., Gyeonggi-do (KR)

(72) Inventor: Byung Soo GO, Gyeonggi-do (KR)

(21) Appl. No.: 18/547,512

(22) PCT Filed: Jun. 1, 2022
(86) PCT No.: PCT/KR2022/007803

§ 371 Date: Aug. 22, 2023

(30) Foreign Application Priority Data
Jun. 9, 2021 (KR) 10-2021-0075167

(51) Int. Cl. G01F 23/80; A01K 5/01; G01F 23/292; G01F 23/296; G06Q 50/02; G08B 21/18

(52) U.S. Cl. CPC G01F 23/804; A01K 5/01; G01F 23/292; G01F 23/296; G06Q 50/02; G08B 21/182

(57) ABSTRACT

Disclosed is a residual feed estimation management server for a feed bin. The residual feed estimation management server for the feed bin according to an embodiment of the present invention includes a communication unit configured to communicate with a measuring terminal installed at a top of an inner side of a feed bin, a gradient generation unit configured to generate gradient information using height information on residual feed measured at a central point of the feed bin using a laser signal of the measuring terminal, and a remaining amount estimation unit configured to estimate a remaining amount of the feed using the gradient information.

### BACKGROUND

### 1. Field of the Invention

The present invention relates to a residual feed estimation management server for a feed bin and a residual feed estimation system, and more specifically, to a technique for measuring and monitoring a height of feed remaining inside a feed bin.

### 2. Discussion of Related Art

Techniques for managing livestock feed include a load cell method of measuring a weight of a feed bin and a laser method of measuring a height of feed inside a feed bin. The load cell method has a problem of frequent breakdowns due to excessive application of a load of a feed bin. The laser method has a problem in that various facilities are required, horizontality should be checked periodically, and information is inaccurate when a laser scatters. Therefore, there is a need for a technique in which an amount of feed in a feed bin can be more easily managed and accurately measured as a technique for controlling an amount of feed in a feed bin on a general livestock farm.

Among the related art, Korean Patent Registration No. 10-1567284 (published on Nov. 13, 2015) relates to a feed amount measuring device using a weight sensor, wherein the feed amount measuring device includes a feed container having a discharge pipe at a lower portion thereof and which is formed in the form of a container filled with feed, a case having a discharge pipe insertion hole into which the discharge pipe of the feed container is inserted is installed in lower portions of a predetermined number of sliders that are installed radially and vertically on an outer surface of the feed container, and into which the feed container is inserted, a predetermined number of guides installed radially and vertically on an inner surface of the case, and a weight sensor installed at a lower portion of the guide to measure weights of the feed container and the feed while a bottom of the slider of the feed container is in contact therewith.

However, the above related art has a limitation in that the existing feed bin cannot be reused and should be replaced with a new one.

### SUMMARY OF THE INVENTION

The present invention is directed to providing a residual feed estimation management server for a feed bin and a residual feed estimation system that can accurately estimate a remaining amount of feed while minimizing errors in height information on the feed remaining inside the feed bin.

The present invention is also directed to providing a residual feed estimation management server for a feed bin and a residual feed estimation system that can timely notify a user of feed replenishment using an amount of feed remaining inside the feed bin.

The present invention is also directed to providing a residual feed estimation management server for a feed bin and a residual feed estimation system that can correct errors through measurement using a laser signal and an ultrasonic sensor of a measuring terminal installed in the feed bin.

The present invention is also directed to providing a residual feed estimation management server for a feed bin and a residual feed estimation system that can reduce a cost of a measuring terminal for measuring feed inside the feed bin and can be easily installed by a non-professional to reduce a burden of an installation cost.

According to an aspect of the present invention, there is provided a residual feed estimation management server for the feed bin, which includes a communication unit configured to communicate with a measuring terminal installed at a top of an inner side of a feed bin, a gradient generation unit configured to generate gradient information using height information on residual feed measured at a central point of the feed bin using a laser signal of the measuring terminal, and a remaining amount estimation unit configured to estimate a remaining amount of the feed using the gradient information.

The gradient generation unit may manage a reference gradient according to a height of the feed learned according to at least one of temperature and humidity inside the feed bin, a type of the feed bin, and a type of the feed, and generate the gradient information according to the height information using the reference gradient.

The remaining amount estimation unit may generate estimation information for notifying an external user terminal of feed replenishment when an amount of change in the gradient information exceeds a preset value.

The residual feed estimation management server may further include a correction unit configured to compare first height information on the feed measured using the laser signal of the measuring terminal with second height information on the feed measured using an ultrasonic sensor of the measuring terminal, and when a height difference exceeds a preset value, correct the gradient information so that the gradient information is generated based on the second height information.

The residual feed estimation management server may further include a failure management unit configured to output a failure signal to the external user terminal when the height information is not received from the measuring terminal.

The residual feed estimation management server may further include a correction unit configured to correct gradient information on a first feed bin using gradient information collected from at least one second feed bin having a similarity with the first feed bin within a preset range.

According to another aspect of the present invention, there is provided a residual feed estimation system, which includes a measuring terminal installed at a top of an inner side of a feed bin, and a residual feed estimation management server for a feed bin including a communication unit configured to communicate with a measuring terminal installed at a top of an inner side of a feed bin, a gradient generation unit configured to generate gradient information using height information on residual feed measured at a central point of the feed bin using a laser signal of the measuring terminal, and a remaining amount estimation unit configured to estimate a remaining amount of the feed using the gradient information.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram of a residual feed estimation system according to an embodiment of the present invention;

FIG. 2 is a configuration diagram of a residual feed estimation management server for a feed bin according to an embodiment of the present invention;

FIG. 3 is an exemplary diagram for describing a case in which a gradient generation unit of the residual feed estimation management server for the feed bin according to FIG. 2 generates gradient information;

FIG. 4 is an exemplary diagram for describing a case in which a remaining amount estimation unit of the residual feed estimation management server for the feed bin according to FIG. 2 notifies a user terminal of a remaining amount of feed; and

FIG. 5 is an exemplary diagram for describing a case in which a failure of a measuring terminal according to FIG. 2 is processed and authentication is performed using a user terminal.

### DETAILED DESCRIPTION OF EXEMPLARY EMBODIMENTS

Hereinafter, embodiments of the present invention will be described in detail with reference to the accompanying drawings. The terms used herein are terms selected in consideration of functions in the embodiments, and the meanings of the terms may vary according to intentions or precedents of users and operators. Therefore, the meanings of the terms used in embodiments to be described below follow definitions of the terms when the terms are specifically defined in this specification, and should be interpreted as meanings generally recognized by those skilled in the art when there is no specific definition.

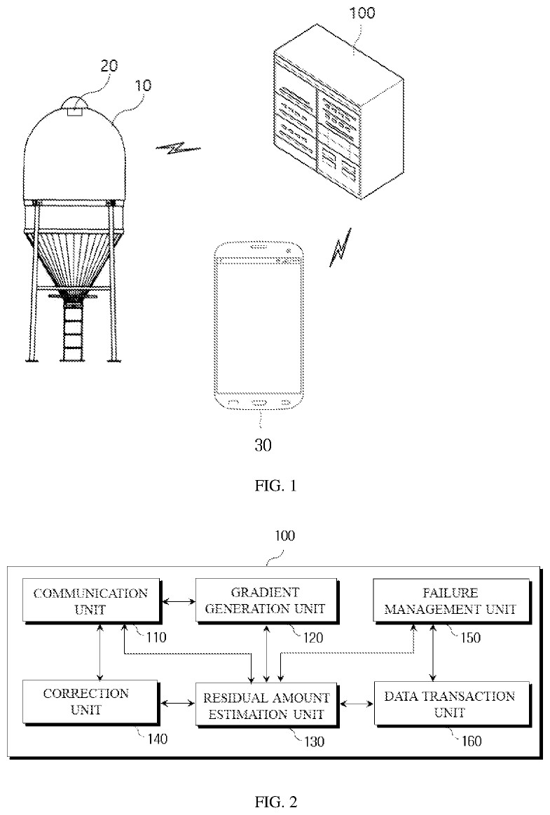

FIG. 1 is a configuration diagram of a residual feed estimation system according to an embodiment of the present invention.

Referring to FIG. 1, the residual feed estimation system includes a feed bin 10, a measuring terminal 20, a user terminal 30, and an estimation management server 100.

The feed bin 10 is a tank for storing feed. The type of feed bin 10 may vary depending on a livestock farm. The shape and size of the feed bin 10 may vary, and model information on the feed bin 10 may be managed by the estimation management server 100. A lid may be formed on an upper portion of the feed bin 10 to seal the inside of the feed bin 10. In this case, the measuring terminal 20 to be described below may be installed inside the lid of the feed bin 10. This is for measuring a height of the feed at the center of the inside of the feed bin 10.

The measuring terminal 20 is a wireless communication terminal installed inside the feed bin 10. The measuring terminal 20 measures the height of the feed inside the feed bin 10. To this end, the measuring terminal 20 may use a laser signal, but the present invention is not necessarily limited thereto. The measuring terminal 20 may measure the height of the feed using an ultrasonic sensor. The measuring terminal 20 may communicate with the estimation management server 100 using a wireless communication network. For example, the measuring terminal 20 may transmit height information to the estimation management server 100 using a long range (LoRa) communication network.

Further, the measuring terminal 20 may use power using the light of the sun. In this case, the measuring terminal 20 may be electrically connected to a solar panel formed on an outer side of the feed bin 10. This is for charging the measuring terminal 20 using the light of the sun without a separate constant power source from the outside in wireless communication with the estimation management server 100. In this case, the measuring terminal 20 is driven with low power, and thus the measuring terminal 20 may be driven for a considerable period of time even when being charged with electricity using the light of the sun.

Further, the measuring terminal 20 may detect a gradient of its own body. The measuring terminal 20 detects the gradient so as not to output a laser signal tilted at a center of the feed bin 10. In this case, a laser signal transceiver of the measuring terminal 20 may be designed in a structure capable of adjusting a gradient. The measuring terminal 20 may vary a gradient of the laser signal transceiver through a horizontal sensor when the gradient of the body exceeds a preset value. The measuring terminal 20 may output the laser signal only when the gradient of the body is within the preset value. Accordingly, it is possible to prevent the height of the feed 11 from being collected inaccurately.

The estimation management server 100 communicates with the measuring terminal 20 to receive the height information. The estimation management server 100 estimates a remaining amount of feed by reflecting the gradient of the entire feed 11 on the basis of the height information on the feed 11 remaining inside the feed bin 10. The estimation management server 100 may communicate with a plurality of measuring terminals 20 to collect and manage height information at a preset time period. The estimation management server 100 may analyze the measured height information to generate gradient information, and estimate a remaining amount of feed on the basis of the gradient information. The estimation management server 100 may monitor the remaining amount of the feed to notify the user terminal 30 of the livestock farm of whether to replenish the feed.

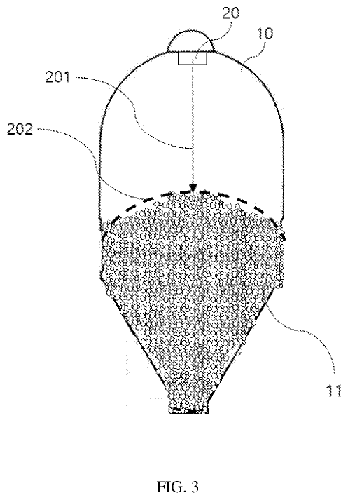

Hereinafter, a residual feed estimation management server 100 for a feed bin will be described in detail with reference to FIGS. 2 to 4.

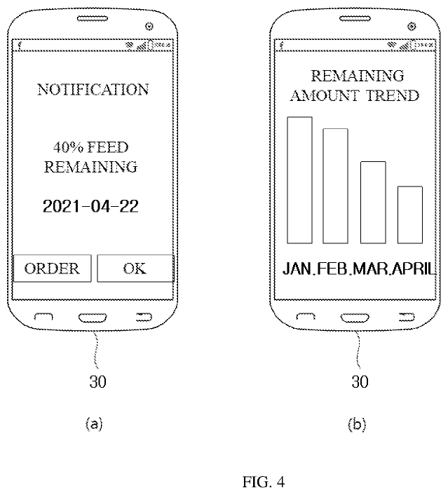

FIG. 2 is a configuration diagram of a residual feed estimation management server for a feed bin according to an embodiment of the present invention, FIG. 3 is an exemplary diagram for describing a case in which a gradient generation unit of the residual feed estimation management server for the feed bin according to FIG. 2 generates gradient information, and FIG. 4 is an exemplary diagram for describing a case in which a remaining amount estimation unit of the residual feed estimation management server for the feed bin according to FIG. 2 notifies a user terminal of a remaining amount of feed.

Referring to FIGS. 1 to 4, the residual feed estimation management server 100 for the feed bin according to the embodiment of the present invention includes a communication unit 110, a gradient generation unit 120, and a remaining amount estimation unit 130.

The communication unit 110 communicates with an external measuring terminal 20. For example, the communication unit 110 may perform wireless communication such as LoRa communication, but the present invention is not necessarily limited thereto. In this case, the measuring terminal 20 is a wireless terminal and is installed at a top of an inner side of a feed bin 10. For example, the measuring terminal 20 may be installed inside a lid of the feed bin 10 to measure a height of feed 11 inside the feed bin. The communication unit 110 receives height information on the feed 11 remaining inside the feed bin 10 from the measuring terminal 20 at a preset time period.

The gradient generation unit 120 generates gradient information using the height information on the residual feed 11 that is measured at a central point of the feed bin 10 using a laser signal of the measuring terminal 20. For example, the height information on the feed 11 inside the feed bin 10 that is measured by the measuring terminal 20 may be measured at the central point of the feed bin 10. The gradient generation unit 120 may generate gradient information using a preset reference gradient for height information. In this case, the reference gradient may be information that is generated by learning gradient information relative to height information measured in a plurality of feed bins 10.

Further, the gradient generation unit 120 may manage the reference gradient according to the height of the feed 11 that is learned according to at least one of temperature and humidity inside the feed bin 10, the type of feed bin 10, and the type of feed 11. The gradient generation unit 120 may collect the height information measured in the plurality of feed bins 10 and the gradient information according to the height information as big data, and analyze the height information and the gradient information. The gradient generation unit 120 may reflect the height information on the feed 11 in at least one element of the temperature and humidity inside the feed bin 10, the type of feed bin 10, and the type of feed 11 to generate the gradient information.

For example, the gradient generation unit 120 may generate the gradient information using a pre-learned gradient pattern. Here, the gradient pattern may be set differently according to the temperature and humidity inside the feed bin 10, the type of feed bin 10, the type of feed 11, and the like. For example, feed A may be set to a point where the height at the center is the highest height, and feed B may be set to a point where the height at the center is the lowest. The gradient generation unit 120 may set the gradient of the residual feed 11 differently according to characteristic information of the feed 11 or feed bin 10.

The remaining amount estimation unit 130 estimates a remaining amount of the feed 11 using the gradient information. The remaining amount estimation unit 130 analyzes a change in the gradient information at a preset time period. The remaining amount estimation unit 130 may estimate the remaining amount of the feed 11 using gradient information for each height. In this case, the remaining amount estimation unit 130 may estimate the remaining amount of the feed 11 according to a preset gradient pattern. The remaining amount estimation unit 130 may determine whether the gradient pattern rises from the center to the periphery or descends from the center to the periphery. Accordingly, it is possible to estimate an amount of the feed inside the feed bin 10 using the gradient information.

Further, the remaining amount estimation unit 130 may generate estimation information for notifying the external user terminal 30 of feed replenishment when an amount of change in the gradient information exceeds a preset value. Here, the external user terminal 30 is a terminal of a manager of a livestock farm or a terminal of a feed supplier. It is possible to increase livestock production by responding more actively by notifying the livestock farm or the feed supplier of a state in which the feed 11 is exhausted and of a time to replenishment of the feed 11 in the future. When the gradient information relative to the height is out of the reference gradient, the remaining amount estimation unit 130 may determine that the state of the feed 11 is an abnormal state, and notify the user terminal 30 of the abnormal state.

Meanwhile, the residual feed estimation management server 100 for the feed bin according to the embodiment of the present invention may further include a correction unit 140.

The correction unit 140 may correct the gradient information on the feed bin 10. For example, the correction unit 140 may correct gradient information on a first feed bin using gradient information collected from one or more second feed bins having a similarity with the first feed bin within a preset range. This is for correcting preset gradient information on the first feed bin by comparing the preset gradient information on the first feed bin with the gradient information on the second feed bin. In other words, by referring to the gradient information on the second feed bins of the same type in addition to the gradient information on the same first feed bin, when a difference between the different gradient information on the feed bin 10 is a predetermined range or more, correction may be made. Accordingly, it is possible to estimate the gradient information on the feed bin 10 more precisely.

Further, the correction unit 140 compares first height information on the feed 11 measured using a laser signal of the measuring terminal 20 with second height information on the feed 11 measured using an ultrasonic sensor of the measuring terminal 20. In this case, when the first height information and the second height information exceed preset values, the correction unit 140 may correct the gradient information to be generated based on the second height information. This is for measuring more accurate height information by comparing the first height information with the second height information using the ultrasonic sensor when the precision of the laser signal of the measuring terminal 20 is lowered.

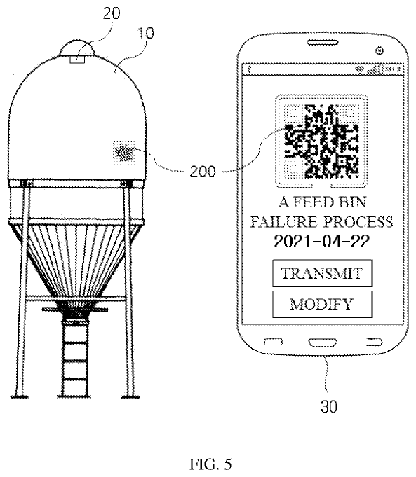

FIG. 5 is an exemplary diagram for describing a case in which a failure of the measuring terminal according to FIG. 2 is processed and authentication is performed using the user terminal.

Referring to FIGS. 1 to 5, the residual feed estimation management server 100 for the feed bin according to the embodiment of the present invention may further include a failure management unit 150.

When height information is not received from the measuring terminal 20 at a preset time period, the failure management unit 150 may output a failure signal to the external user terminal 30. This is for determining the measuring terminal 20 to be a failure and notifying the user of replacement of the measuring terminal 20. Even when a gradient of the measuring terminal 20 exceeds a preset value, the failure management unit 150 may output a failure signal. This is for preventing the measuring terminal 20 from obtaining inaccurate height information. When the gradient of the measuring terminal 20 exceeds the preset value, the failure management unit 150 may vary a location of the laser signal transceiver.

Further, the failure management unit 150 may determine whether a state of the failure has changed according to whether a processing signal is received from the user terminal 30 within a predetermined period of time after transmitting the failure signal to the user terminal 30. For example, when an identification code 200 formed on the feed bin 10 or the measuring terminal 20 is obtained and transmitted to the user terminal 30, the failure management unit 150 may authenticate that the failure has been processed. In this case, the state of the failure of the measuring terminal 20 may be changed to a normal state. Accordingly, when the measuring terminal 20 fails, whether the user has confirmed the fact that the measuring terminal 20 fails may be verified.

Meanwhile, the residual feed estimation management server 100 for the feed bin according to the embodiment of the present invention may further include a data transaction unit 160.

The data transaction unit 160 may transact gradient information. In this case, the gradient information including identification information of a user is managed. The identification information is for encrypting the gradient information, and a quick response (QR) code may be used as the identification information, but the present invention is not necessarily limited thereto. The data transaction unit 160 may transact the gradient information in response to a request of a third party. This is for being used as reference data in other livestock farms or feed companies or for research purposes on the basis of estimation information on the feed 11 remaining inside the feed bin 10. The data transaction unit 160 may encrypt and transact the gradient information to prevent the third party from checking the gradient information without permission.

Further, the data transaction unit 160 may set a modification authority for the gradient information. For example, the data transaction unit 160 may distinguish between a first authority allowing the gradient information to simply be read and a second authority allowing reading and writing of the gradient information. This is for preventing the gradient information from being changed without permission by the third party. In this case, the data transaction unit 160 my combine the identification information to modified gradient information obtained by modifying the gradient information and encrypt the modified gradient information. Accordingly, only one with permitted authority may modify and use primitive gradient information from the feed bin 10.

Further, the data transaction unit 160 may perform data mining on an association between user information such as the history, experience, and license of the third party who wants to purchase the gradient information and the gradient information. In this case, when the association between the user information and the gradient information is greater than or equal to a preset value, the data transaction unit 160 may grant authority for any one or more of collection, processing, distribution, and viewing of the gradient information to the user. Accordingly, it is possible to differentially grant and manage authority of the user according to whether the user has a qualification related to the gradient information.

Accordingly, it is possible to accurately estimate a remaining amount of feed while minimizing errors in height information on the feed remaining inside a feed bin.

Further, it is possible to timely notify a user of feed replenishment using the amount of the feed remaining inside the feed bin.

Further, it is possible to correct errors through measurement using a laser signal and an ultrasonic sensor of a measuring terminal installed in the feed bin.

The present invention has been particularly described with reference to exemplary embodiments described with reference to the accompanying drawings, but is not limited thereto. Therefore, the present invention should be interpreted by the description of claims intended to cover the obvious modifications that can be derived from the described embodiments.

What is claimed is:

1. A residual feed estimation management server for a feed bin, comprising:
a communication unit configured to communicate with a measuring terminal installed at a top of an inner side of a feed bin;
a gradient generation unit configured to generate gradient information on an upper portion of residual feed located at a point in a vertical direction from a central point of the feed bin using height information on the residual feed measured at the central point of the feed bin using a laser signal of the measuring terminal, wherein the gradient generation unit manages a reference gradient according to a height of the feed learned according to at least one of temperature and humidity inside the feed bin, a type of the feed bin, and a type of the feed, and generates the gradient information according to the height information using the reference gradient;
a remaining amount estimation unit configured to estimate a remaining amount of the feed using the gradient information;
a failure management unit configured to output a failure signal to an external user terminal when the height information is not received from the measuring terminal at a preset time period or a gradient of the measuring terminal exceeds a preset value, and authenticate that a failure has been processed when an identification code formed on the feed bin or the measuring terminal is obtained and transmitted to the user terminal within a predetermined period of time; and
a data transaction unit configured to set a right to modify the gradient information, combine identification information of a user to modified gradient information obtained by modifying the gradient information, encrypt the modified gradient information, and transact the modified gradient information.

2. The residual feed estimation management server of claim 1, wherein the remaining amount estimation unit generates estimation information for notifying the external user terminal of feed replenishment when an amount of change in the gradient information exceeds a preset value.

3. The residual feed estimation management server of claim 1, further comprising a correction unit configured to compare first height information on the feed measured using the laser signal of the measuring terminal with second height information on the feed measured using an ultrasonic sensor of the measuring terminal, and when a height difference exceeds a preset value, correct the gradient information so that the gradient information is generated based on the second height information.

4. The residual feed estimation management server of claim 1, further comprising a correction unit configured to correct gradient information on a first feed bin using gradient information collected from at least one second feed bin having a similarity with the first feed bin within a preset range.

5. A residual feed estimation system comprising:
a measuring terminal installed at a top of an inner side of a feed bin; and
a residual feed estimation management server for the feed bin, which includes a communication unit configured to communicate with the measuring terminal, a gradient generation unit configured to generate gradient information on an upper portion of residual feed located at a point in a vertical direction from a central point of the feed bin using height information on the residual feed measured at the central point of the feed bin using a laser signal of the measuring terminal, wherein the gradient generation unit manages a reference gradient according to a height of the feed learned according to at least one of temperature and humidity inside the feed bin, a type of the feed bin, and a type of the feed, and generates the gradient information according to the height information using the reference gradient, a remaining amount estimation unit configured to estimate a remaining amount of the feed using the gradient information, a failure management unit configured to output a failure signal to an external user terminal when the height information is not received from the measuring terminal at a preset time period or a gradient of the measuring terminal exceeds a preset value, and authenticate that a failure has been processed when an identification code formed on the feed bin or the measuring terminal is obtained and transmitted to the user terminal within a predetermined period of time, and a data transaction unit configured to set a right to modify the gradient information, combine identification information of a user to modified gradient information obtained by modifying the gradient information, encrypt the modified gradient information, and transact the modified gradient information.
